(19) United States
(12) Patent Application Publication
(10) Pub. No.: US 2016/0346840 A1
(43) Pub. Date: Dec. 1, 2016

(54) ADDITIVE LAYER MANUFACTURING METHOD

(71) Applicant: Rolls-Royce plc, London (GB)

(72) Inventors: Daniel CLARK, Derby (GB); David M J POOLE, Derby (GB); Ian C D CARE, Derby (GB)

(73) Assignee: Rolls-Royce plc, London (GB)

(21) Appl. No.: 15/160,725

(22) Filed: May 20, 2016

(30) Foreign Application Priority Data
May 27, 2015 (GB) 1509033.5

(51) Int. Cl. B22F 3/105; G06K 1/12; G06K 19/06; B22F 5/00

(52) U.S. Cl. CPC B22F 3/1055; B22F 5/00; G06K 1/121; G06K 19/06037; B33Y 10/00

(57) ABSTRACT

A method of forming a component includes defining an identification pattern, defining one or more scanning parameters and/or one or more heating parameters, depositing a sinterable material on a substrate and scanning a heat source of the deposited sinterable material to thereby selectively sinter the material to the substrate to produce a sintered layer having the identification pattern. The sintered layer includes first and second regions, and the method includes sintering the first region using one or more scanning parameters and/or one or more heating parameters having a first value, and sintering the second region using one or more scanning parameters and/or one or more heating parameters having a second value to thereby produce the identification pattern including a contrast between the first and second regions.

The present disclosure concerns a method of manufacturing a component using an additive layer method, in order to mark the component.

Additive layer manufacture (ALM), also known as “3D printing” involves forming a 3D solid component from multiple layers of material fused together. Examples include stereolithography (in which a curable material is selectively hardened by a laser) and selective laser sintering (SLS, described in US2004094728, in which a metal powder or wire is selectively heated, in order to sinter (i.e. consolidate) the powder to produce the component) among others.

ALM permits relatively low cost manufacture of components, and is particularly beneficial for components having low production runs, as setup costs are relatively low, since the same machine can be used to produce different components.

However, ALM also increases the risk of counterfeiting, since a genuine part can be scanned using techniques such as structured light scanning, and reproduced using ALM relatively cheaply and accurately. Counterfeiting is a particular problem in the field of aerospace, since the performance of many components is safety critical, and counterfeited parts may have lower performance compared to Original Equipment Manufacturer (OEM) parts, for example due to the use of inferior materials.

Consequently, there is a need for a method of additive layer manufacturing which can be used to mark the part to identify its origin, or other properties of the part. Such methods must not affect the performance of the part, and must be themselves difficult to copy. It is also desirable that the method does not involve additional processing steps for applying the marking, since this would increase manufacturing costs.

Several previous methods are known for applying part markings to additive layer manufactured parts. US2005225004 discloses adding different coloured dyes to the sinterable powder, which are then built into a sub-layer of the part. However, this method requires modifications to the sintering apparatus, and is relatively easy to reproduce.

US2012203365 discloses a method of providing a machine readable 3-D tag on a surface of a sintered part. However, again, such a method is relatively easily scannable and reproduceable, and may affect the surface properties of the component.

US2010035084 discloses a method of implanting magnetic media within a 3d printed component. However, such a media may have different material properties to the remainder of the component, and so would represent an internal weakness. Additional expense will also be incurred in providing the magnetic media.

According to a first aspect of the invention there is provided a method of forming a component, the method comprising:

defining an identification pattern;

defining one or more scanning parameters and/or one or more heating parameters

depositing a sinterable material on a substrate;

scanning a heat source of the deposited sinterable material to thereby selectively sinter the material to the substrate to produce a sintered layer having the identification pattern; wherein

the sintered layer comprises first and second regions, the method comprising sintering the first region using one or more scanning parameters and I or one or more heating parameters having a first value, and sintering the second region using one or more scanning parameters and/or one or more heating parameters having a second value to thereby produce the identification pattern comprising a contrast between the first and second regions.

It has been found by the inventors that varying at least one of the heating and/or scanning parameters of the scanning step results in visible changes the surface of the component. These changes can be used to encode an identification pattern in the surface of the component, to thereby prevent copying. While the identification pattern is readily identifiable, the pattern or scanning/heating parameters required to cause the change may be difficult to identify. Since the changes are essentially two-dimensional, conventional 3d scanning techniques cannot be used to copy the pattern. The changes also do not significantly affect the surface or bulk properties of the component, and so can be used on high performance, safety critical items such as aerospace components. The identification pattern can be applied using existing additive layer manufacturing equipment in a single step.

The step of defining the identification pattern may comprise defining information to be conveyed by the part, and translating the information to a machine readable pattern.

The scanning parameters may comprise one or more of scanning pass speed, scanning pass direction, scanning pass pattern, scanning pass overlap, scanning pass dithering, scanning pass angle, heating source distribution and heating source axis. By changing one or more of these scanning parameters, a detectable surface change is provided, for example a different surface orientation, which provides contrast between the first and second regions to form the identification pattern. It has been found that these parameters can be significantly adjusted to provide a contrast, without affecting the structural characteristics of the surface.

The heating parameters may comprise one or more of heating source spot shape, heating source intensity and heating source timing. Again, it has been found that these heating parameters can be adjusted to provide a contrast, without affecting the surface properties of the component.

The heating source may comprise any one of a laser and an electron beam.

Where the contrast between the first and second regions is provided by different scanning pass patterns, the identification pattern may comprise a space filling curve, the first and second regions defining different space filling curves.

The method may further comprise defining an obfuscation pattern. The obfuscation pattern may comprise a plurality of pseudo-random surface orientations in which the identification pattern is encoded. The obfuscation pattern may be defined by the first and second regions. Advantageously, in order to read the identification pattern, the obfuscation pattern must first be identified, which may not be apparent to an observer without additional equipment.

The obfuscation pattern may comprise a plurality of spaced lines defined by differently oriented surface regions formed by the first and second regions. Consequently, the spaced lines may provide a diffraction pattern when scanned with laser light. Consequently, such an arrangement may be more difficult to scan using a laser light source, and so more difficult to copy, since a detector would detect the diffraction pattern generated by the spaced lines, rather than the obfuscation pattern itself.

According to a second aspect of the invention, there is provided a kit of parts comprising a component having an obfuscation pattern comprising an identification pattern produced in accordance with the method of the first aspect of the invention; and

a transparent overlay comprising a plurality of refractive zones configured to diffract light in accordance with the obfuscation pattern to reveal the identification pattern.

Advantageously, the identification of the identification pattern can only conveniently be carried out in combination with the transparent overlay, since the transparent overlay effective “cancels out” the obfuscation pattern in view of the refractive zones. Consequently, without the overlay, copying of the identification is more complex, resulting in further hurdles for a counterfeiter to overcome.

The transparent overlay may comprise a prismatic sheet of transparent material, the prisms being oriented in accordance with the obfuscation pattern. The transparent material may comprise a plastics material.

The transparent overlay may comprise a birefringent material that when oriented in accordance with the obfuscation pattern reveal information or a message. The pattern may be a repeating pattern in order that the overlay does not have to be precisely located.

The skilled person will appreciate that except where mutually exclusive, a feature described in relation to any one of the above aspects of the invention may be applied mutatis mutandis to any other aspect of the invention.

Embodiments of the invention will now be described by way of example only, with reference to the Figures, in which:

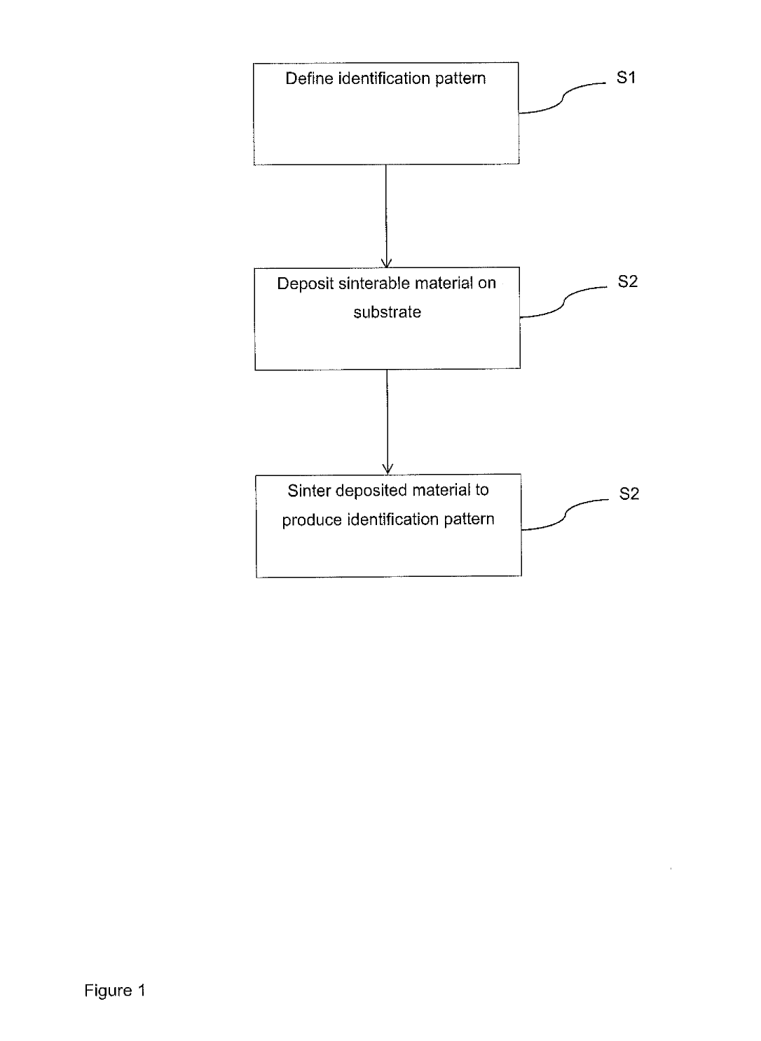

FIG. 1 is a flow diagram illustrating a method of forming a component in accordance with the present disclosure;

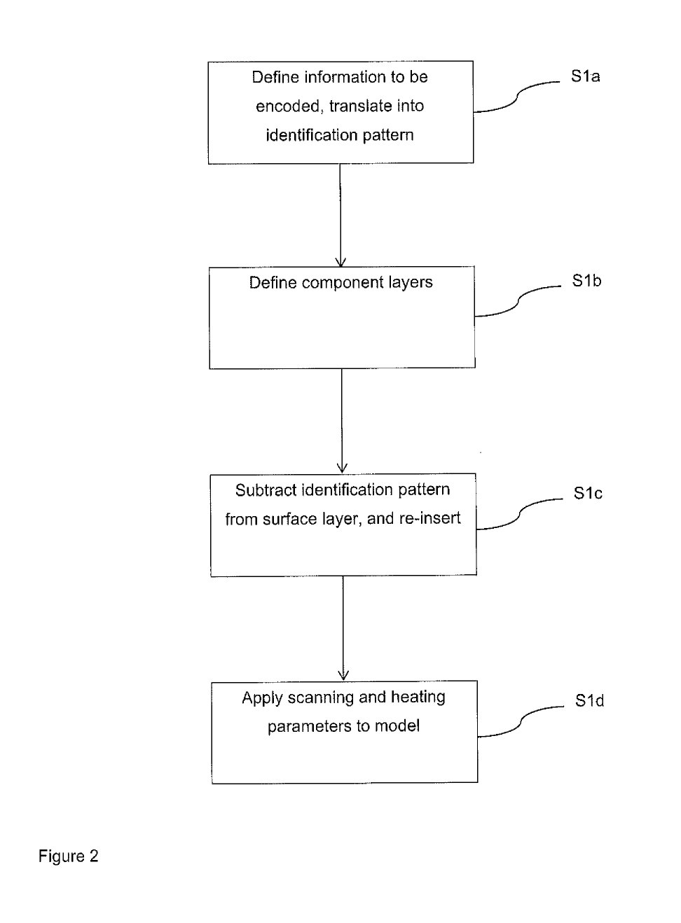

FIG. 2 is a flow diagram illustrating the first step of the method of FIG. 1;

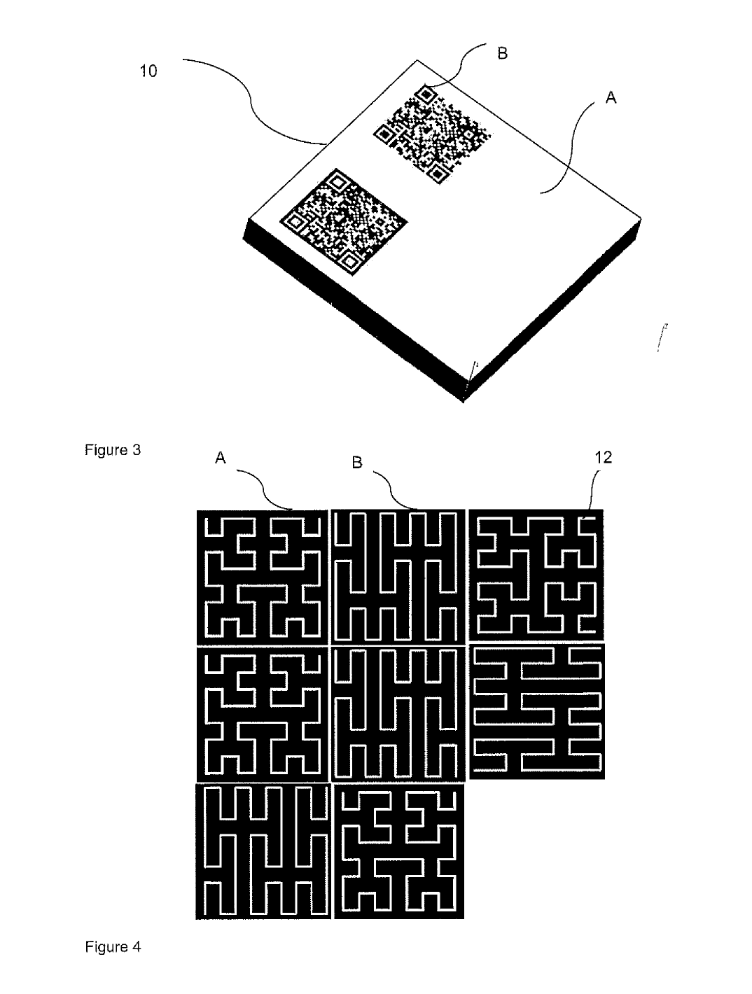

FIG. 3 is a perspective view of a component formed in accordance with the present disclosure comprising a first identification pattern;

FIG. 4 is a plan schematic view of 2-D matrices in the form of space filling curves;

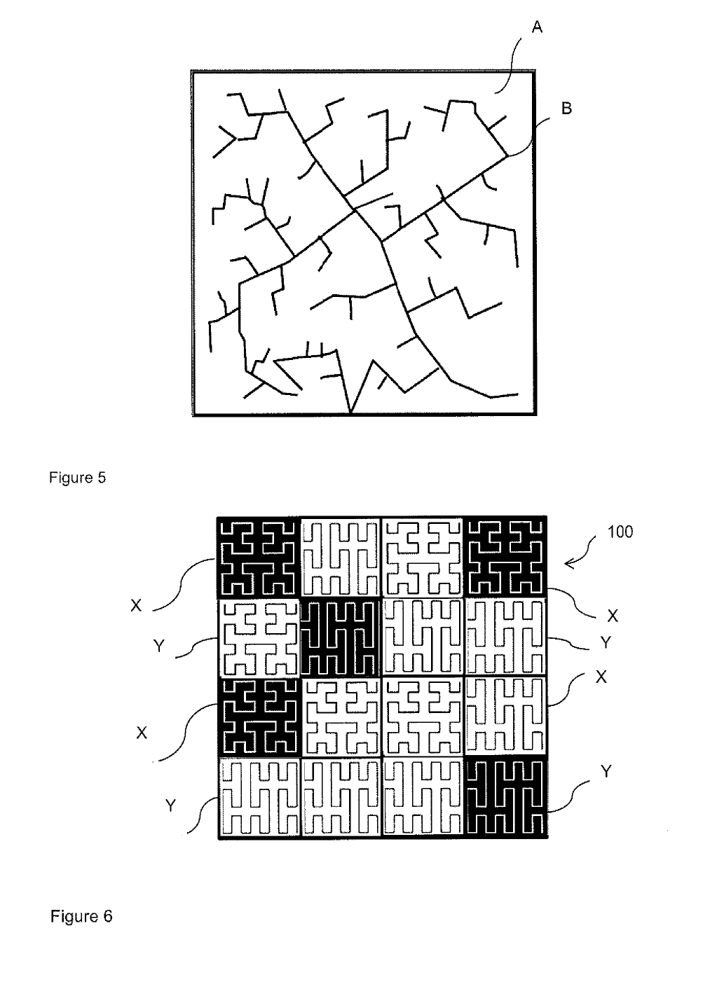

FIG. 5 is a plan schematic view of Information encoded utilising the position of nodes, length of lines and orientation of lines;

FIG. 6 is a plan schematic view of a second identification pattern in accordance with the present disclosure within an obfuscation pattern;

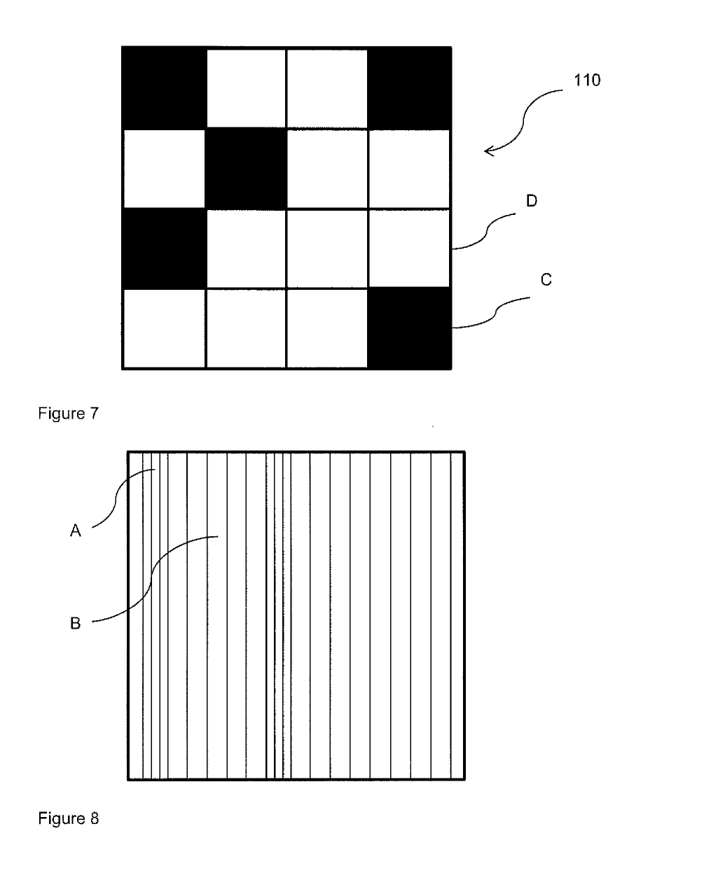

FIG. 7 is a plan schematic view of an overlay sheet used to read the embedded information;

FIG. 8 is a plan schematic view of Information encoded utilising raster lines.

FIG. 1 shows a process flow diagram illustrating a method of forming a component in accordance with the present disclosure. The component could for example comprise a metallic component or a plastics component. In one example, the component is a housing for electrical equipment. In a first step S1, an identification pattern is defined.

FIG. 2 shows the first step S1 in more detail. In a first sub-set step S1a, the identification pattern is defined by first defining part data to be encoded in the identification pattern. This could include information such as the manufacturer, model, part identifying information and batch of the component. Due to the relatively large amount of information that can be encoded, information regarding the machine or machine operator that created the component can also be encoded. This information is used to create an identification pattern, which in a first example, is in the form of a QR code in which the part data is to be encoded.

In a second sub-step S1b, the dimensions of the part to be manufactured are defined. This generally comprises a plurality of layers of material, which define the component as a whole. Typically, this step is carried out on a general purpose computer using suitable Computer Assisted Design (CAD) software, such as “Magics”™, which may operate on a file in the STL format.

In a third sub-step S1c, the identification pattern identified in step S1a is subtracted from a top surface layer of the geometry defined in step S1b. The identification pattern is then re-inserted into the top surface layer, in the location where the identification pattern was subtracted. This creates a continuous surface layer comprised of two regions—the original surface layer (i.e. comprising a first region A), and the identification pattern (comprising a second region B).

In a fourth sub-step S1d, the CAD model of the component generated in the third sub-step S1c is transferred to additive layer process software such as EOS PSW™. In this step, scanning and heating parameters are assigned to the first and second regions A, B. The same scanning and heating parameters are applied to the first region A as the parameters for the preceding layers (if present) on the basis of the parameters required in order to provide desired physical component characteristics. However, different scanning and/or heating parameters are assigned to the second region B of the surface layer, as will be described in further detail below.

The scanning parameters comprise one or more of scanning pass speed, scanning pass direction, scanning pass pattern, scanning pass overlap spacing, scanning pass dithering, scanning pass angle, heating source distribution and heating source axis. By changing one or more of these scanning parameters, a detectable surface change is provided, for example a different surface orientation, which provides contrast between the first and second regions to form the identification pattern. The heating parameters may comprise one or more of heating source spot shape, heating source intensity, heating source timing and heating source duty cycle. Again, it has been found that these heating parameters can be adjusted to provide a contrast, without affecting the surface properties of the component.

The heating/scanning parameters of both the first and second regions must provide acceptable physical characteristics for the component, yet also provide an observable effect on the surface of the sintered component. In one example, the first region is scanned at a velocity of 500 mm/s using a heating power of 160 W, while the second region is scanned at a velocity of 1000 mm/s at a heating power of 195 W. This combination of scanning/heating parameters has been found to result in significantly different surface orientations in the finished article in the first and second regions, while also providing acceptable surface physical characteristics. The heating time and scan speed depend on a number of variables including the material type, powder size, layer thickness, component solidity and previous layer residual heat. The above parameters are thought to be suitable since they have been found to alter one or more of the shape, size, orientation or depth of the weld pool, and so affect the final surface characteristics (in particular surface orientation and roughness) of the article. By defining different areas formed by different parameters, these differences can be used to encode information on the component.

It has been found that varying the lay orientation and spacing of the heat source passes is highly effective in creating an observable contrast between the first and second regions. Changing the heat source axis between the regions has also been found to be effective in experiments. Where the heating source is an electron beam, the electron beam dither can be altered to change the heating of the surface layer, resulting in similar effects.

In the second step S2, the model is then supplied to an Additive Layer Manufacturing machine (ALM), such as a laser or electron beam sintering machine. One suitable example is an electron beam sintering machine produced by Arcam™. The electron beam sintering machine is then used to add layers of sinterable material, and then, in a third step S3, sinter the material using the scanning and heating parameters for the first and second regions defined in the first step S1.

The above described method provides a method of forming and marking a component that does not change the component integrity, or require any additional machining process steps or equipment. The method is easy to read, but difficult to replicate, as a large amount of trial and error may be required to determine what process parameters are required to generate the observed surface characteristics.

FIG. 3 shows an example identification pattern 12 applied to a component 10. In this case, the identification pattern comprises a 2-D data matrix in the form of a QR-Code. In this example, the first region A is represented by the white areas of the surface, while the black areas B represent the second region. A visible contrast is detectable between the two regions A, B. In this example, the surface is formed by the ALM apparatus using different heating/scanning parameters such that the first region A has a different surface facet angle compared to the second region B. Consequently, when light is shone at the component at a particular angle, the contrast between the first and second regions A, B is revealed. By concealing the pattern in a part of the article 10 not easily visible, and by limiting the angle of light required to reveal the pattern, the pattern may not be revealed to a casual observer, making replication of the pattern in a counterfeit part difficult. At the very least, the final surface finish of the article will have to be reproduced to a higher fidelity, increasing production costs to the counterfeiter. This can be enhanced by changing the laser angle when scanning the black areas B. The identification pattern could be read by a human operator, or automatically by a machine vision system/automated visual inspection system.

Other 2D data matrices can be utilised, such as a space filling curve. FIGS. 4 and 6 provide further examples of 2-D matrices in the form of space filling curves.

In the space filling curve of FIG. 4, data is encoded by a continuous pattern, which fills the entire space of the surface. In this case, the first and second regions A, B are represented by different scanning patterns. The first region A comprises areas of the component which are scanned in accordance with a first scanning pattern, while the second region B comprises areas of the component which are scanned using a second scanning pattern. Information is encoded by providing different space filling patterns in a grid like pattern. For example, the pattern in grid A could represent a “1”, while the pattern in grid B could represent a “0”.

Similarly, in FIG. 5, first and second regions A, B are defined by different scanning and heating parameters, with the black lines representing the first region A, and the white area representing the second region B, which may have one or both of different heating parameters and scanning parameters to the first region. Information may be encoded in the position of nodes, length of lines and orientation of lines.

In a second embodiment of the present disclosure, the method may comprise encoding the identification pattern within an obfuscation pattern. The obfuscation pattern comprises a plurality of random or pseudo-random surface facet orientations. The surface facet orientations themselves do not contain the necessary data, but rather portions of the surface having a particular orientation contain the identification pattern data. For example, FIG. 6 shows an example surface layer of a component 100. The black background squares X having white lines comprise surface areas of the component having a first orientation (for example, angled upwardly somewhat), whereas the white background squares Y having black lines comprise surface areas having a second orientation different alternative to the first orientation (for example, regions which are downwardly angled).

The data could be encoded in the first and second areas using any of the techniques discloses above, such as different heating or scanning parameters, utilising techniques such as different space filling patterns for example (as shown in FIG. 6).

Under normal lighting conditions, the identification pattern as encoded by the space filling pattern would not be visible, but would merely appears as surface roughness. Due to parts of the identification pattern having a different surface orientation to other parts of the identification pattern, no single lighting orientation or viewing angle could be used to reveal the identification pattern. In more complex embodiments, further surface orientations could be used, for example, left and right orientations.

In order to reveal the identification code to an operator, a transparent overlay sheet 110 is provided, as shown in FIG. 7. In this embodiment, the transparent overlay sheet 110 comprises a transparent plastics sheet comprising a grid of different facet angles C, D, which corresponds to the facet angles of the obfuscation pattern (with black squares C representing the areas having the first orientation X, and white squares D representing areas having the second orientation Y). Consequently, the plastics sheet will (when held in the correct orientation and position) diffract light passing through the sheet to the same plane, thereby revealing the identification pattern to a user. Consequently, the code can only be read in conjunction with the overlay sheet, thereby enhancing security. Each component may comprise a plurality of codes—one for a user, and one for the manufacturer. Each code could then only be read using a corresponding overlay. The pattern shown in FIG. 7 is simplistic and in practice would be repeated such that the overlay does not have to be precisely located when used to reveal the information.

In a still further embodiment, as shown in FIG. 8, the pattern could be encoded using first regions A having closely spaced raster/scanning lines, and second regions B having raster lines spaced further apart. Consequently, when shone with light (preferably using a coherent light source such as laser light), an interference pattern is produced by the reflected light due to the different surface orientations produced by the raster lines. This interference pattern could encode the identification data. Again, reproducing the pattern of lines from the interference pattern is relatively difficult, and would at least require higher precision duplication of the surface of the article. Utilising this raster line interference, this can be used to create a false information for a regular (fixed space interval scanner) such that a part produced by this method can impose a message such as “fake” or “invalid” on the part made by copying.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of forming a component, the method comprising:
defining an identification pattern;
defining one or more scanning parameters and/or one or more heating parameters;
depositing a sinterable material on a substrate;
scanning a heat source of the deposited sinterable material to thereby
selectively sinter the material to the substrate to produce a sintered layer having the identification pattern; wherein
the sintered layer comprises first and second regions, the method comprising sintering the first region using one or more scanning parameters and/or one or more heating parameters having a first value, and sintering the second region using one or more scanning parameters and/or one or more heating parameters having a second value to thereby produce the identification pattern comprising a contrast between the first and second regions.

2. A method according to claim 1, wherein the step of defining the identification pattern comprises defining information to be conveyed by the part, and translating the information to a machine readable pattern.

3. A method according to claim 1, wherein the scanning parameters comprises one or more of scanning pass speed, scanning pass direction, scanning pass pattern, scanning pass overlap, scanning pass dithering, scanning pass angle, heating source distribution and heating source axis.

4. A method according to claim 1, wherein the heating parameters comprise one or more of heating source spot shape, heating source intensity and heating source timing.

5. A method according to claim 1, wherein the heating source may comprise any one of a laser and an electron beam.

6. A method according to claim 3, wherein the identification pattern comprises a space filling curve, the first and second regions defining different space filling curves.

7. A method according to claim 1, wherein the method comprised defining an obfuscation pattern.

8. A method according to claim 7, wherein the obfuscation pattern comprises a plurality of pseudo-random surface orientations in which the identification pattern is encoded.

9. A method according to claim 7, wherein the obfuscation pattern comprises a plurality of spaced lines defined by differently oriented surface regions formed by the first and second regions.

10. A kit of parts comprising a component having an obfuscation pattern comprising an identification pattern produced in accordance with the method of claim 1;
a transparent overlay comprising a plurality of refractive zones configured to diffract light in accordance with the obfuscation pattern to reveal the identification pattern.

11. A kit of parts according to claim 10, wherein the transparent overlay comprises a prismatic sheet of transparent material, the prisms being oriented in accordance with the obfuscation pattern.

12. A kit of parts according to claim 11, wherein the transparent material comprises a plastics material.

13. A kit of parts according to claim 10, wherein the transparent overlay comprises a birefringent material that when oriented in accordance with the obfuscation pattern reveal information or a message.
